(19) United States
(12) Patent Application Publication
(10) Pub. No.: US 2008/0059411 A1
(43) Pub. Date: Mar. 6, 2008

(54) Performance-based job site management system

(75) Inventors: Jonny Ray Greiner, Dunlap, IL (US); Giles Kent Sorrells, Metamora, IL (US); Richard Lee Gordon, East Peoria, IL (US); Anthony James Grichnik, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/513,528

(22) Filed: Aug. 31, 2006

(51) Int. Cl. G06F 17/30

(52) U.S. Cl. 707/2

(57) ABSTRACT

A performance-based job site management system for a machine environment includes a plurality of monitoring devices for collecting productivity data associated with a machine and transmitting the productivity data to an on-board data collector associated with the machine. The system also includes a project management system communicatively coupled to the on-board data collector. The project management system is configured to receive the productivity data from the on-board data collector and analyze the productivity data based on predetermined performance criteria. The system also assesses machine performance based on the productivity analysis and evaluate job site performance based on the machine performance. The system also provides recommendations for improving job site performance based on the evaluation and adjusts one or more operational aspects associated with the machine, based on the recommendations.

### TECHNICAL FIELD

The present disclosure relates generally to remote management systems and, more particularly, to a performance-based job site management system for machine environments.

### BACKGROUND

Project management is an integral part of any work environment, particularly environments having multiple machines cooperating to perform a plurality of tasks such as, for example, a mine or construction environment. For these types of work environments, efficient and effective coordination of subtasks for each machine is imperative to the successful operation and execution of the project. In some situations, the coordination and scheduling of equipment subtasks may be complicated, as each project task may require multiple pieces of equipment, the operations of which may depend on other equipment and/or subtasks. For example, in a mine environment, coordinating route schedules for material hauling equipment may depend upon productivity and pace of excavation equipment.

Manual methods of project management have been developed and implemented with some success in smaller work environments. However, as the amount of equipment and number of tasks associated with the work environment increases, these manual methods may become inefficient and complicated due to the added complexities of additional equipment and tasks. Furthermore, because performance of one or more pieces of equipment may depend on the real-time performance of one or more other pieces of equipment, manual methods may not provide the adequate speed and responsiveness to adjust to project changes in real-time. Thus, in order to efficiently and accurately manage large, multi-task work environments, an automated project management system may be required.

At least one system for automating certain project management tasks is described in U.S. patent application Publication No. 2002/0065698 (“the '698 publication”) to Schick et al. The '698 publication describes a system for managing a plurality of mobile assets that includes collecting mobile asset data; developing historical usage and health information for the asset, based on the data; and distributing the information across and information network. The system may also include determining a level of wear of the asset based on the collected data and providing service recommendations for the mobile asset based on wear and usage data.

Although the system of the '698 publication may provide certain repair and maintenance-oriented project management solutions, it may be inefficient. For instance, the system of the '698 publication may manage certain repair and maintenance activities associated with individual machines, but does nothing to provide project and/or job site management capabilities for entire work environments employing multiple assets. Thus, environments that rely on management of tasks and equipment based on productivity of certain other tasks and equipment may become inefficient.

Additionally, because the system of the '698 publication does not provide a productivity-based management solution, should one or more assets become unproductive or inefficient, the system is not equipped to compensate for this loss of productivity. As a result, changes in productivity and/or efficiency of, one asset may negatively affect the productivity and/or efficiency of other assets, potentially jeopardizing the efficiency of the entire work environment. Thus, work environments that rely on real-time response to changes in asset productivity may become inefficient.

The disclosed system and method for performance-based job site management are directed towards overcoming one or more of the problems set forth above.

### SUMMARY OF THE INVENTION

In accordance with one aspect, the present disclosure is directed toward a performance-based job site management system for a machine environment. The system may include a plurality of monitoring devices for collecting productivity data associated with a machine and transmitting the productivity data to an on-board data collector associated with the machine. The system may also include a project management system communicatively coupled to the on-board data collector. The project management system may be configured to receive the productivity data from the on-board data collector and analyze the productivity data based on predetermined performance criteria. The system may assess machine performance based on the productivity analysis and evaluate job site performance based on the performance of the machine or one or more other machines. The system may also provide recommendations for improving job site performance based on the evaluation and adjust one or more operational aspects associated with the machine, based on the recommendations.

According to another aspect, the present disclosure is directed toward a method for performance-based job site management of a machine environment. The method may include receiving productivity data associated with a machine and analyzing the productivity data based on predetermined performance criteria. Machine performance may be assessed based on the productivity analysis, and job site performance may be evaluated based on the machine performance. The method may also include providing recommendations for improving job site performance based on the evaluation, and adjusting one or more operational aspects associated with the machine, based on the recommendations.

In accordance with yet another aspect, the present disclosure may be directed toward a method for performance-based job site management. The method may include receiving productivity data associated with each of a first machine and a second machine operating in a machine environment. The performance of each of the first and second machines may be assessed based on the productivity data. Based on this assessment, a productivity factor associated with each of the first and second machines may be determined. An operational aspect associated with the first machine may be adjusted if the productivity factor associated with the first machine is less than the productivity factor associated with the second machine. Alternatively, an operational aspect associated with the second machine may be adjusted if the productivity factor associated with the second machine is less than the productivity factor associated with the first machine.

### BRIEF DESCRIPTION OF THE DRAWINGS

FIG. 1 provides a diagrammatic illustration of a project environment according to an exemplary disclosed embodiment;

FIG. 2 provides a schematic illustration of the exemplary disclosed project environment of FIG. 1; and

FIG. 3 provides a flowchart depicting an exemplary performance-based job site management process associated with the disclosed embodiments.

### DETAILED DESCRIPTION

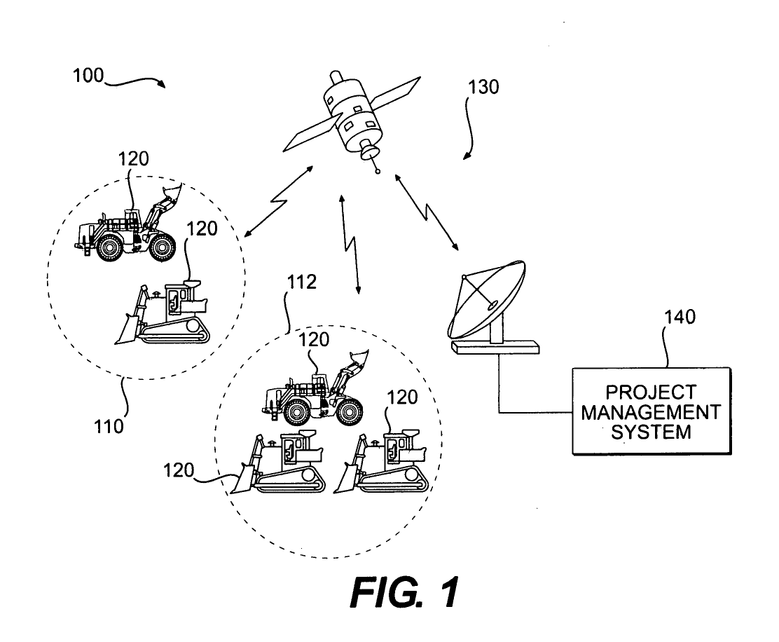

FIG. 1 illustrates an exemplary project environment 100 consistent with certain disclosed embodiments. Project environment 100 may include components that perform individual tasks that contribute to a machine environment task, such as mining, construction, transportation, agriculture, manufacturing, or any other type of task associated with other types of industries. For example, project environment 100 may include one or more machines 120 coupled to a project management system 140 via a communication network 130. The project environment 100 may be configured to monitor, collect, and filter information associated with an operation of one or more machines 120 and distribute the information to one or more back-end systems, such as project management system 140. It is contemplated that additional and/or different components than those listed above may be included in project environment 100.

Machines 120 may each be a fixed or mobile machine configured to perform an operation associated with project environment 100. Thus, machine, as the term is used herein, refers to a fixed or mobile machine that performs some type of operation associated with a particular industry, such as mining, construction, farming, etc. and operates between or within project environments (e.g., construction site, mine site, power plants, etc.) A non-limiting example of a fixed machine includes an engine system operating in a plant or off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment. A machine may be driven by a combustion engine or an electric motor. The types of machines listed above are exemplary and not intended to be limiting. It is contemplated that project environment 100 may implement any type of machine. Accordingly, although FIG. 1 illustrates machines 120 as particular types of machines, each machine 120 may be any type of machine operable to perform a particular function within project environment 100. Furthermore, it is contemplated that machines 120 may include a first set of machines 110 and a second set of machines 112 for associating the operations of particular machines to groups of machines. Furthermore, it is also contemplated that first and second sets of machines may be located in separate work sites located remotely from each other, and with project management system 140.

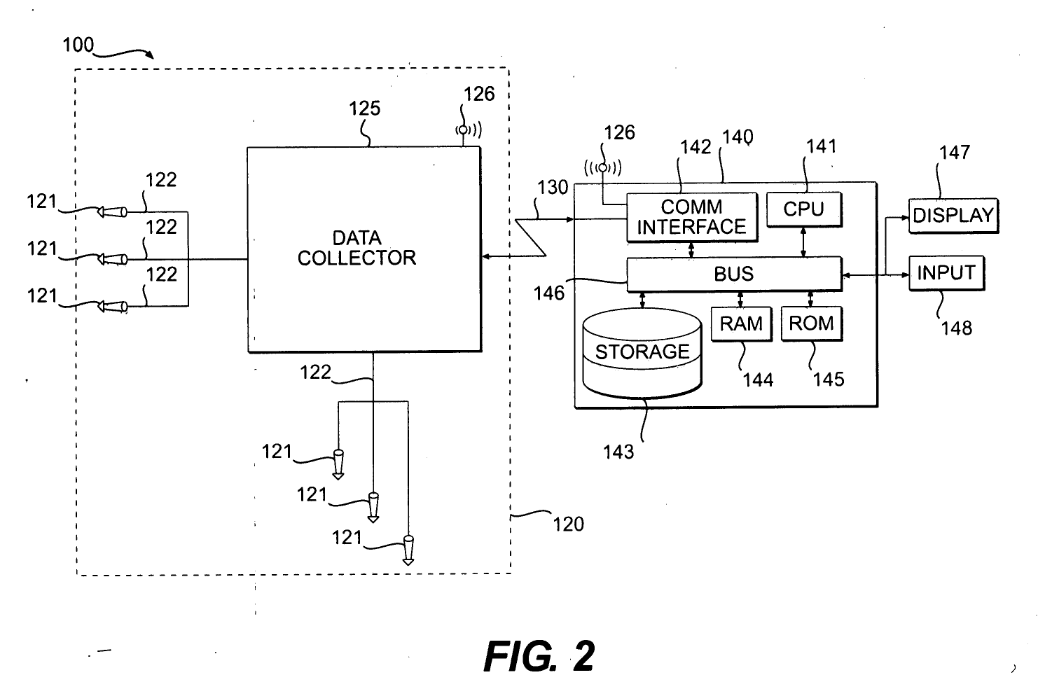

In one embodiment, each machine 120 may include on-board data collection and communication equipment to monitor, collect, and/or transmit information associated with an operation of one or more components of machine 120. As shown in FIG. 2, machine 120 may include, among other things, one or more monitoring devices 121, such as sensors coupled to one or more data collectors 125 via communication lines 122, one or more transceiver devices 126, and/or any other such components for monitoring, collecting, and communicating information associated with the operation of machine 120. Each machine 120 may also be configured to receive information from off-board systems, such as a project management system 140, network server (not shown), or any other back-end communication system. The components described above are exemplary and not intended to be limiting. Accordingly, the disclosed embodiments contemplate each machine 120 including additional and/or different components than those listed above.

Monitoring devices 121 may include any type of sensor or sensor array and may be associated with one or more components of machine 120 such as, for example, a power source, a torque converter, a transmission, a work implement, a fluid supply, a traction device, and/or other components and subsystems of machine 120. Monitoring devices 121 may be configured to automatically gather operation and/or productivity data associated with one or more components and/or subsystems of machine 120. Operation data, as the term is used herein may include, for example, implement, engine, and/or machine speed and/or location: fluid pressure, flow rate, temperature, contamination level, and or viscosity of a fluid; electric current and/or voltage levels; fluids (i.e., fuel, oil, etc.) consumption rates; loading levels (i.e., payload value, percent of maximum payload limit, payload history, payload distribution, etc.); transmission output ratio, slip, etc.; grade; traction data; scheduled or performed maintenance and/or repair operations; and any other suitable operation data. Productivity data, as the term is used herein may include, for example, machine speed, cycle time associated with the performance of one or more tasks, material and/or payload weight, volume, or type, historic load data associated with one or more machines from previous operations of the respective machine, or any other type of data indicative of the productivity of one or more machines. It is contemplated that sensing devices may be associated with additional, fewer, and/or different components and/or subsystems associated with machine 120 than those listed above.

Data collector 125 may be operable to collect operational information associated with machine 120 from monitoring devices 121 and determine a productivity based on the collected operational information and task parameters assigned to machine 120. For example, data collector 125 may collect operational information associated with an operation of machine 120 during the execution of an assigned task. Data collector 125 may determine the productivity of machine 120 based on the collected operational information and one or more task parameters associated with the assigned task. Data collector 125 may distribute the operational information and productivity information to project management system 140 via communication network 130.

Communication network 130 may include any network that provides two-way communication between each machine 120 and an off-board system, such as project management system 140. For example, communication network 130 may communicatively couple machines 120 to project management system 140 across a wireless networking platform such as, for example, a satellite communication system. Alternatively and/or additionally, communication network 130 may include one or more other broadband communication platforms appropriate for communicatively coupling one or more machines 120 to project management system 140 such as, for example, cellular, Bluetooth, microwave, point-to-point wireless, point-to-multipoint wireless, multipoint-to-multipoint wireless, or any other appropriate communication platform for networking a number of components. Although communication network 130 is illustrated as a satellite-based wireless communication network, it is contemplated that communication network 130 may include wireline networks such as, for example, Ethernet, fiber optic, waveguide, or an, other type of wired communication network.

Project management system 140 may include any computing system configured to receive, analyze, and distribute operational data received from one or more machines 120 via communication network 130. For purposes of this disclosure, operation data may include operational and/or productivity information indicative of one or more parameters associated with the operation of a particular machine 120. For example, operational information may include status data (e.g., engine on/off, parked, stationary, etc.), load weight, engine speed, engine temperature, oil pressure, location, GPS coordinates, engine hours, tire wear, component fatigue, fluid levels, pressure data, machine position information, and any other parameter associated with the operation of a machine. Productivity information may include information indicative of the productivity of machine 120 such as, for example, ground speed, payload weight, payload type, load history data, an amount of material moved, how quickly the machine was able to complete a particular task associated with project environment 100, an amount of energy expended by machine 120 during operations within project environment 100, an efficiency in completing an assigned task, or any other suitable indicator of machine productivity.

In one embodiment, project management system 140 may include hardware and/or software components that perform processes consistent with certain disclosed embodiments. For example, as illustrated in FIG. 2, project management system 140 may include one or more transceiver devices 126, a central processor unit (CPU) 141, a communication interface 142, one or more computer-readable memory devices, including storage device 143, a random access memory (RAM) module 144, and a read-only memory (ROM) module 145, a display device 147, and/or an input device 148. The components described above are exemplary and not intended to be limiting. Furthermore, it is contemplated that project management system 140 may include alternative and/or additional components than those listed such as, for example, one or more software programs including instructions for executing process steps when executed by CPU 141.

CPU 141 may be one or more processors that execute instructions and process data to perform one or more processes consistent with certain disclosed embodiments. For instance, CPU 141 may execute software that enables project management system 140 to request and/or receive operation data from data collector 125 of machines 120. CPU 141 may also execute software that stores collected operation data in storage device 143. In addition, CPU 141 may execute software that enables project management system 140 to analyze operation data collected from one or more machines 120, modify one or more project specifications of the project environment 100, and/or provide customized productivity reports, including recommendations for modifications to project specifications and/or operational instructions for executing the project and or machines associated therewith. A project specification may include one or more characteristics associated with the execution of a machine project such as, for example, a project schedule for completion of the machine project, a productivity schedule for each respective machine operating in project environment 100, a project productivity rate (e.g., percentage of project completed per month), a project budget, a productivity quota for machine 120, maintenance schedules, hours of operation for the machine and/or job site, an assignment for a particular machine, a job site inventory, and any other type of characteristic associated with project management. Furthermore, a project specification may include a guideline that, when used as a project benchmark, may assist in the appropriate execution of a project performed within project environment 100. These benchmarks may include incremental completion milestones, budget forecasts, and any other type of performance and/or operation benchmark.

CPU 141 may be connected to a common information bus 146 that may be configured to provide a communication medium between one or more components associated with project management system 140. For example. common information bus 146 may include one or more components for communicating information to a plurality of devices. CPU 141 may execute sequences of computer program instructions stored in computer-readable medium devices such as, for example, a storage device 143, RAM 144, and/or ROM 145 to perform methods consistent with certain disclosed embodiments, as will be described below.

Communication interface 142 may include one or more elements configured for communicating data between project management system 140 and one or more data collectors 125 via transceiver device 126 over communication network 130. For example, communication interface 142 may include one or more modulators, demodulators, multiplexers, demultiplexers, network communication devices, wireless devices, antennas, modems, and any other type of device configured to provide data communication between project management system 140 and remote systems or components.

One or more computer-readable medium devices may include one or more storage devices 143, a RAM 144, ROM 145, and/or any other magnetic, electronic, or optical data computer-readable medium devices configured to store information, instructions, and/or program code used by CPU 141 of project management system 140. Storage devices 143 may include magnetic hard-drives, optical disc drives, floppy drives, or any other such information storing device. A random access memory (RAM) device 144 may include any dynamic storage device for storing information and instructions by CPU 141. RAM 144 also may be used for storing temporary variables or other intermediate information during execution of instructions to be executed by CPU 141. During operation, some or all portions of an operating system (not shown) may be loaded into RAM 144. In addition, a read only memory (ROM) device 145 may include any static storage device for storing information and instructions by CPU 141.

Project management system 140 may include one or more input devices configured to receive one or more project specifications (e.g., project schedule, job site inventory, project budget, individual machine tasks, etc.) indicative of a project to be performed by a plurality of machines from one or more users associated with project environment 100. For example, project management system may include a console with integrated keyboard and mouse to allow a user of project management system_(e.g., customer, client, etc.) to input project specifications corresponding to a particular project to be performed as part of project environment I 00. Project management system 140 may store the project specifications in storage device 143 for future analysis and/or modification. The components listed above are exemplary only and not intended to be limiting. Accordingly, additional, fewer, and/or different input devices may included with project management system 140.

Project management system 140 may be coupled to on-board data collection and communication equipment to monitor, collect, and/or transmit information associated with an operation of one or more components of machine 120. In one embodiment, project management system 140 may be coupled to one or more data collectors 125 on respective machines 120 via transceiver device 126 to collect operation and/or productivity data from one or more monitoring devices 121 and/or any other components for monitoring, collecting, and communicating information associated with the operation of a respective machine 120. Project management system 140 may also be configured to transmit information to machine 120 via communication network 130.

Project management system 140 may also include other components that perform functions consistent with certain disclosed embodiments. For instance, project management system 140 may include a memory device configured to store, among other things, one or more software applications including, for example, a database program, a graphical user interface, data acquisition and analysis software, or any other appropriate software applications for operating and/or monitoring project environment I 00.

Project management system 140 may further include one or more components to analyze operational and/or productivity information from machines 120 with respect to predetermined operational data stored in storage device 143. For example, in addition to CPU 141, project management system 140 may be configured with on-board logic circuitry that analyzes operation data received from machines 120. Predetermined operational criteria may include data indicative of an appropriate operation of a particular machine 120, type of machine 120, etc. For example, predetermined operational criteria may include, for example, benchmark operational ranges, stress-strain thresholds, mechanical force limits, fuel economy, temperature ranges, pressure ranges, load limits, or any other such predefined specification benchmarking the performance of a machine during normal operations. Moreover, each of the predetermined operational criteria may be associated with one or more components of machine 120 such as, for example, a combustion engine, a motor, a transmission, a fluid cooling system, a generator, a cooling tank, a lubricating fluid, or any other component of machine 120.

Additionally, project management system 140 may further include one or more components 10 analyze productivity information from machines 120 with respect to predetermined performance criteria stored in storage device 143. Predetermined performance criteria may include data indicative of certain productivity thresholds associated with an operation of a particular machine 120 or type of machine. For example, predetermined performance criteria may include a payload limit associated with a piece of hauling equipment, a load capacity associated with an excavator bucket, or any other type of productivity benchmark associated with a machine. Alternatively, predetermined performance criteria may include a predefined percent efficiency or productivity factor programmed by a user or project manager to provide a desired performance benchmark associated with machine 120. For instance, a project manager may specify a desired efficiency for dump trucks associated with a particular task at 85% of rated payload value. Accordingly, the predetermined performance criteria may be programmed to 85% as a performance benchmark for use during analysis or the productivity data associated with machine 120.

Project management system 140 may also be configured to provide recommendations for improving the performance of the job site and/or one or more machines associated with the job site, based on the operational and/or productivity analysis. In one example, project management system 140 may provide instructions to an operator of an underperforming machine to increase payload during subsequent operations. In another example, project management system 140 may provide instructions to one or more haul machine operators to increase ground speed to compensate for a break-down of one of the other haul machines on a particular route. Accordingly, an operator may adjust machine operations in response to these recommendations and/or instructions.

In certain embodiments, project management system 140 may modify an operational aspect associated with project environment I 00 based on the status of one or more machines 120. For example, project management system 140 may modify a task schedule and/or project specification to compensate for any machines that have been incapacitated or taken off-line for service. Alternatively and/or additionally, project management system 140 may modify one or more additional and/or different project specifications associated with other machines operating within the same work site to reflect a respective change associated with project environment 100. For instance, should one or more machines 120 of first set 110 of machines become disabled, project management system may adjust an operational aspect and/or productivity requirement of the other machines in the set to compensate for the lost productivity of the disabled. This adjustment may include modification of a speed and/or a productivity benchmark associated with one or more of the machines. Alternatively and/or additionally, one or more project specifications (e.g., project schedule, project budget, task assignments. etc.) may be adjusted based on a change associated with the project environment.

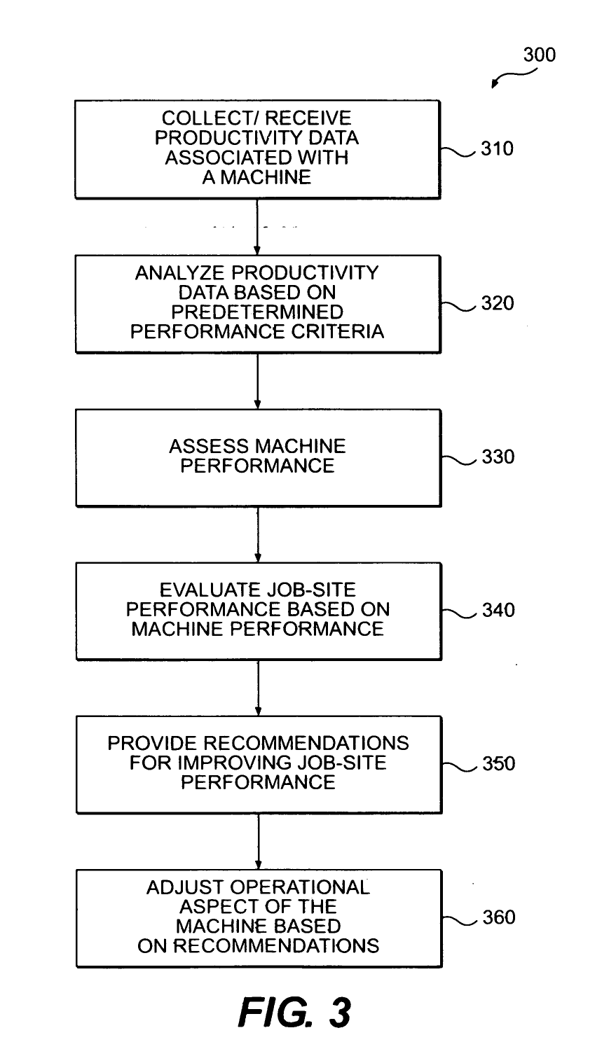

Processes and methods consistent with the disclosed embodiments provide performance-based project management solutions, whereby certain operations of machines or machine components may be adjusted to compensate for performance and/or productivity changes associated with a job site. FIG. 3 provides a flowchart 300 depicting an exemplary disclosed performance-based project management process consistent with certain disclosed embodiments. According to one embodiment, project management system 140 may receive operation and/or productivity data associated with machine 120 (Step 310). Project management system 140 may receive this data automatically (i.e., in “real-time”) from data collector 125. Alternatively and/or additionally, project management system 140 may receive operational and/or productivity data periodically, either by requesting (and subsequently receiving) the data from data collector 125 or by directly downloading the data from data collector 125 via communication network 130.

Project management system 140 may analyze the productivity data associated with the machine based on predetermined performance criteria (Step 320). Project management system 140 may include one or more productivity analysis tools, such as productivity analysis software, which, when executed, compare collected productivity data associated with machine 120 to one or more predetermined and/or user-defined benchmark criteria. For example, project management system 140 may compare productivity data indicative of a current payload weight associated with a particular machine with a designed payload capacity associated with the machine. In another example, project management system 140 may analyze ground speed, engine RPMs, and/or a transmission gear ratio with respect to machine design specifications to determine if the machine is operating within an appropriate range.

Upon analyzing the productivity data, project management system 140 may assess the machine performance, based on the analysis (Step 330). This assessment may be based upon a desired productivity level associated with a particular machine or type of machine. The desired productivity level may include, for example, a minimum percent efficiency associated with a particular machine that is defined by a project manager prior to performing a particular tasks. For instance, a minimum productivity level associated with a particular type of machine performing task “A” may be defined as 85%. To asses machine performance, project management system 140 may compare current payload efficiency with the minimum productivity level to determine whether a particular machine is under-performing, over-performing, or performing as expected. For example, a machine operating at a 70% rated payload efficiency, indicating that the machine is currently loaded with 70% of the rated payload amount, may be classified as under-performing, while a machine operating at 95% of rated payload amount may be classified as over-performing.

Based on the performance assessment of each machine, project management system 140 may evaluate the performance of the entire job site (Step 340). The job site performance assessment may include analyzing certain current project specifications along with the performance assessment of the machines associated with the project to identify particular areas of performance deficiency. For example, for a particular task associated with a job site, project management system may determine that a current performance level associated with the job site may not satisfy certain project specifications such as, for example, a project schedule or project budget.

According to one embodiment, project management system 140 may evaluate job site performance by averaging the productivity factors and/or efficiency data of each machine associated with a particular task, to determine an estimated productivity associated with the task. This task productivity estimate may be compared with a predetermined task productivity benchmark defined by a project manager. This predetermined benchmark may be based on a number of criteria, including, for example, a task schedule or task budget specified by a project foreman. It is contemplated that job site productivity may be determined using operations or processes in addition to or instead of averaging. Those skilled in the art will recognize that various method or estimating job site performance may be used and/or supplemented, without departing from the scope of the present disclosure.

Upon evaluating the performance of the job site, project management system 140 may provide one or more recommendations for improving job site performance based on the evaluation (Step 350). For example, project management system 140 may generate a project report outlining one or more tasks associated with the job site. The report may identify each machine associated with each task and provide a corresponding performance factor (e.g., percent efficiency, current-vs.-historic payload data, etc.) associated with each machine. The report may also include performance assessments associated with each machine including, for example, whether the machine is under-performing based on the desired performance productivity level associated with the particular machine. The report may also include certain recommendations for increasing the performance of a particular task, including recommendations for adjusting operational aspects associated with certain machines. These recommendations may include, for example, increasing a ground speed associated with one or more machines in order to expedite certain tasks, increasing minimum desired productivity levels (e.g., minimum payload levels) for certain machines, adjusting route intervals between haul routes, or requesting modification of certain equipment hardware such as, for example, ordering a larger bucket for an excavator to accommodate more material.

Based on the recommendations, one or more operational aspects associated with one or more machines may be adjusted (Step 360). For example, project management system 140 may provide instructions to an operator of a machine 120 in order to modify an operational aspect of the machine. These instructions may include, for example, payload adjustment instructions, speed adjustment requests, task scheduling modifications, task performance modifications etc. Alternatively and/or additionally, certain operational aspects may be automatically adjusted by project management system 140. For example, project management system 140 may be communicatively coupled to an electronic control unit of one or more machines and configured to provide commands for automatically adjusting machine speed by increasing fuel flow to an engine chamber and/or by adjusting the transmission shift pattern or gear ratio.

### INDUSTRIAL APPLICABILITY

Although methods and systems consistent with the disclosed embodiments are described in relation to project environments having a plurality of mobile machines, they may be applicable to any environment where it may be desirable to provide management decisions based on real-time productivity associated with entities operating within the environment. Specifically, the disclosed performance-based job site management system is directed toward managing machine and job site tasks associated with a project environment, in an effort to maximize project productivity and efficiency. By analyzing a productivity associated with each of a plurality of machines operating in a machine environment and adjusting certain operational aspects associated with one or more machines based on the productivity analysis, the presently disclosed system provides an integrated, real-time, and performance-based project management system.

The presently disclosed performance-based job site management system may have several advantages. Because the system collects and analyzes productivity data in addition to health and status data, it may provide a more robust project management solution than conventional systems that simply monitor health and status information. As a result, this performance-based job site management system may provide project managers and machine operators with real-time instructions for increasing productivity of the project environment. According to certain embodiments, the presently disclosed system may adjust certain operational aspects associated with one or more machines automatically. in an effort to increase overall productivity and efficiency associated with the job site.

In addition, the presently disclosed system may be more responsive than conventional project management systems that rely on manual productivity analysis. For example, because the system provides real-time productivity analysis and control, the system may detect, report, and/or compensate for any changes in productivity associated with one or more machines automatically, without requiring manual analysis by a project manager. As a result, delays associated with project management systems that use manual productivity analysis to adjust job site operations may be reduced and/or eliminated.

It will be apparent to those skilled in the art that various modifications and variations can be made to the disclosed performance-based job site management system (and associated methods) without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A performance-based job site management system for a machine environment comprising:
a plurality of monitoring devices for collecting productivity data associated with a machine and transmitting the productivity data to an on-board data collector associated with the machine;
a project management system communicatively coupled to the on-board data collector and configured to:
receive the productivity data from the on-board data collector:
analyze the productivity data based on predetermined performance criteria:
assess machine performance based on the productivity analysis;
evaluate job site performance based on the machine performance:
provide recommendations for improving job site performance based on the evaluation; and
adjust one or more operational aspects associated with the machine, based on the recommendations.

2. The system of claim 1, wherein at least one of the plurality of monitoring devices includes a device for estimating the ground speed associated with the machine.

3. The system of claim 1, wherein at least one of the plurality of monitoring devices includes a payload sensor for estimating a size associated with a load of the machine.

4. The system of claim 1, wherein the productivity data includes at least one of load history data, speed, cycle time,-material weight, material volume, or material type.

5. The system of claim 1, wherein the project management system is communicatively coupled to the on-board data collector via a wireless communication link.

6. The system of claim 1, wherein the one or more operational aspects includes a ground speed associated with the machine.

7. The system of claim 6, wherein the on-board data collector includes an electronic control unit of the machine and adjusting the one or more operational aspects includes providing? to the electronic control unit, a speed adjustment command to modify the ground speed associated with the machine.

8. The system of claim 1, wherein the one or more operational aspects includes a transmission ratio associated with the machine.

9. The system of claim 8, wherein the on-board data collector includes an electronic control unit of the machine and adjusting the one or more operational aspects includes providing, to the electronic control unit, an transmission command signal to modify a gear setting associated with the transmission ratio.

10. A method for performance-based job site management of a machine environment comprising:
receiving productivity data associated with a machine;
analyzing the productivity data based on predetermined performance criteria;
assessing machine performance based on the productivity analysis;
evaluating job site performance based on the machine performance;
providing recommendations for improving job site performance based on the evaluation; and
adjusting one or more operational aspects associated with the machine, based on the recommendations.

11. The method of claim 10, wherein the productivity data includes at least one of load history data, speed, cycle time, material weight, material volume, or material type.

12. The method of claim 10, wherein assessing the machine performance includes estimating a performance factor associated with the machine based on the productivity data.

13. The method of claim 12, wherein the performance factor includes a percent efficiency of the machine.

14. The method of claim 10, wherein evaluating job site performance includes:
estimating the percent efficiency of one or more tasks associated with the job site based on the machine performance; and
comparing the percent efficiency of the one more tasks with a minimum efficiency threshold corresponding to the respective task.

15. The method of claim 10, wherein the one or more operational aspects includes a ground speed associated with the machine.

16. The method of claim 15, wherein adjusting the one or more operational aspects includes providing, to an electronic control unit of the machine, a speed adjustment command to modify the ground speed associated with the machine.

17. A method for performance-based job site management comprising:
receiving productivity data associated with each of a first machine and a second machine operating in a machine environment;
assessing the performance of each of the first and second machines based on the productivity data;
determining, based on the assessment, a productivity factor associated with each of the first and second machines;
adjusting an operational aspect associated with the first machine if the productivity factor associated with the first machine is less than the productivity factor associated with the second machine; and
adjusting an operational aspect associated with the second machine if the productivity factor associated with the second machine is less than the productivity factor associated with the first machine.

18. The method of claim 17, wherein the productivity data includes at least one of load history data, speed, cycle time, material weight, material volume, or material type.

19. The method of claim 17, wherein the one or more operational aspects includes a ground speed associated with the machine.

20. The method of claim 19, wherein adjusting the one or more operational aspects includes providing, to an electronic control unit of the machine, a speed adjustment command to modify the ground speed associated with the machine.
